(19) United States
(12) Patent Application Publication
(10) Pub. No.: US 2005/0219867 A1
(43) Pub. Date: Oct. 6, 2005

(54) Thermal distribution system for voltage regulator

(76) Inventors: Mai H. Loc, Aloha, OR (US); John A. Dickerson, Beaverton, OR (US); Peter T. Li, Portland, OR (US)

Correspondence Address: BUCKLEY, MASCHOFF, TALWALKAR LLC, 5 ELM STREET, NEW CANAAN, CT, 06840, US

(21) Appl. No.: 10/813,377

(22) Filed: Mar. 30, 2004

(51) Int. Cl. H02M 3/335

(52) U.S. Cl. 363/20

(57) ABSTRACT

A system may include a voltage regulator converter, the voltage regulator converter comprising N (N>1) phases, and a voltage regulator controller coupled to the voltage regulator converter and to control the voltage regulator converter to generate a first current within a first one of the N phases and to generate a second current within a second one of the N phases, wherein the first current is different from the second current.

### BACKGROUND

An integrated circuit (IC) may be designed to operate in conjunction with a specified range of supply voltages. Supply voltages that fall outside this range may cause speed path problems and/or IC degradation. A voltage regulator is often used to generate an appropriate supply voltage for use by an IC.

A voltage regulator may consist of several elements that generate significant amounts of heat. These elements may be spaced apart on a substrate, such as a motherboard, to which the voltage regulator is mounted. Over time, these spaced voltage regulator elements may compromise the functionality of heat-sensitive elements located nearby or of the substrate itself. Accordingly, the heat-sensitive elements may be replaced with elements that are more heat-tolerant (and usually more expensive) and/or the voltage regulator may be operated at a lower current level so that the above-described voltage regulator elements generate smaller amounts of heat.

### BRIEF DESCRIPTION OF THE DRAWINGS

FIG. 1 is a block diagram of a system according to some embodiments.

FIG. 2 is a block diagram of a voltage regulator according to some embodiments.

FIG. 3 is diagram of a process according to some embodiments.

FIG. 4 is a top view of a system according to some embodiments.

### DETAILED DESCRIPTION

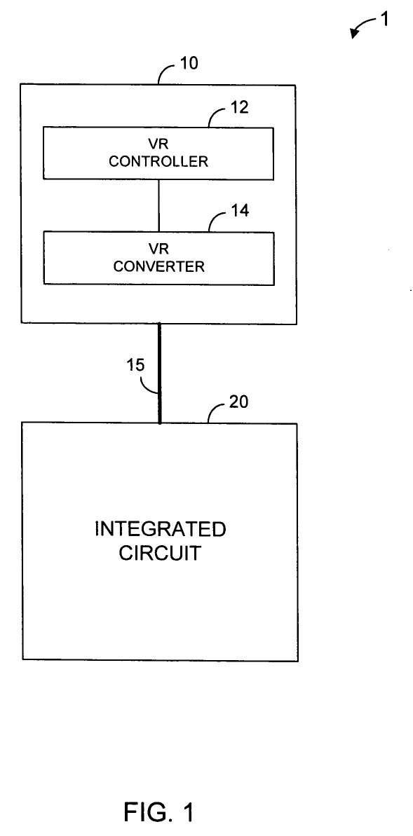

FIG. 1 is a block diagram of system 1 according to some embodiments. System 1 comprises voltage regulator 10, which in turn comprises voltage regulator controller 12 and voltage regulator converter 14. Voltage regulator 10 outputs a supply voltage to power bus 15, which in turn provides the supply voltage to IC 20. IC 20 may comprise a microprocessor or any suitable IC. System 1 may be used in a computer motherboard or in any other platform according to some embodiments. For example, voltage regulator 10 may be implemented as a voltage regulator “module” that is mounted to a substrate that in turn may be coupled to a motherboard, as a voltage regulator “down” that is mounted directly on a motherboard, or in any other fashion.

Generally, voltage regulator 10 may comprise any currently- or hereafter-known device to provide a supply voltage having a particular value to IC 20. According to some embodiments, voltage regulator controller 12 transmits a control signal to voltage regulator converter 14. Voltage regulator converter 14 then adjusts the supply voltage, with the value of the supply voltage being controlled by the control signal. Voltage regulator converter 14 may comprise a multi-phase Buck regulator or any other suitable device. Further details of voltage regulator converter 14 according to some embodiments are provided below.

In some embodiments, voltage regulator converter 14 comprises two or more phases as is known in the art. Voltage regulator controller 12 may control voltage regulator converter 14 to generate a first current within a first one of the phases and to generate a second current within a second one of the phases. According to some embodiments, electrical elements of one of the first and second phases may therefore generate less heat than electrical elements of the other one of the first and second phases. The phase that generates less heat may be located in an area of a substrate that is more thermally-sensitive than the area in which the other phase is located. Heat experienced by the more thermally-sensitive area of the substrate may therefore be reduced without reducing a total current that is generated by voltage regulator 10.

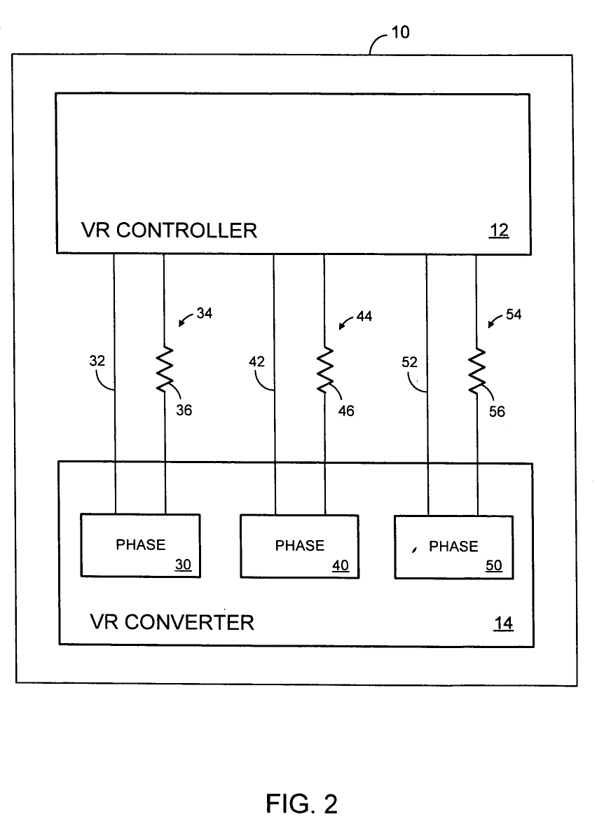

FIG. 2 is a block diagram of voltage regulator 10 according to some embodiments. As shown, voltage regulator converter 14 includes three phases, phase 30, phase 40, and phase 50. Voltage regulator controller 12 may control voltage regulator converter 14 such that at least one of phase 30, phase 40, and phase 50 generates a unique current.

More specifically, voltage regulator controller 12 may transmit control signals via control lines 32, 42 and 52 to control a respective one of phases 30, 40, and 50 to generate a current. A current generated by one of phases 30, 40, and 50 may differ from a current generated by one other of phases 30, 40, and 50 according to some embodiments. For example, voltage regulator may be required to output a 1.5V supply voltage having a current of 30 A. Voltage regulator controller 12 may therefore control voltage regulator converter 14 to generate a 11 A current within phase 30, a 8 A current within phase 40, and a 11 A current within phase 50. Such an embodiment may be useful in a case that phase 40 is located in a thermally-sensitive area.

FIG. 2 also shows feedback circuits 34, 44, and 54, each of which is coupled to voltage regulator controller 12 and to a respective one of phases 30, 40 and 50. Each of feedback circuits 34, 44, and 54 may transmit a signal based on which voltage regulator controller 12 may determine a current generated by a respective one of phases 30, 40, and 50. Feedback circuits 34, 44, and 54 may include any number of electrical elements according to some embodiments, some or all of which may be located within voltage regulator converter 14 and/or voltage regulator controller 12. According to some embodiments, one or more electrical elements of one of feedback circuits 34, 44, and 54 exhibits an electrical value that is different from an electrical value exhibited by a corresponding one or more electrical elements of another one of feedback circuits 34, 44, and 54.

Each of feedback circuits 34, 44, and 54 of FIG. 2 includes a respective one of resistors 36, 46, and 56. In some embodiments, a resistance value associated with at least one of resistors 36, 46, and 56 is different from a resistance value associated with at least one other of resistors 36, 46, and 56. Resistors 36, 46, and 56 may be considered to be current-sensing resistors according to some embodiments.

Returning to the above-mentioned particular example, resistor 36 may comprise a 800Ω resistor, resistor 46 may comprise a 800Ω resistor, and resistor 56 may comprise a 0Ω resistor. Such values may cause voltage regulator controller 12 to control voltage regulator converter 14 to generate a 11 A current within phase 30, a 11 A current within phase 40, and a 8 A current within phase 50. In some embodiments, voltage regulator controller 12 is designed to control voltage regulator converter 14 to generate a substantially identical current within each of phases 30, 40, and 50 in a case that the values of resistors 36, 46 and 56 are substantially identical. Accordingly, the current generated within each of phases 30, 40, and 50 may be changed in such embodiments by changing the values of one or more of resistors 36, 46, and 56 so that a resistance value associated with one of resistors 36, 46, and 56 is different from a resistance value associated with another one of resistors 36, 46, and 56.

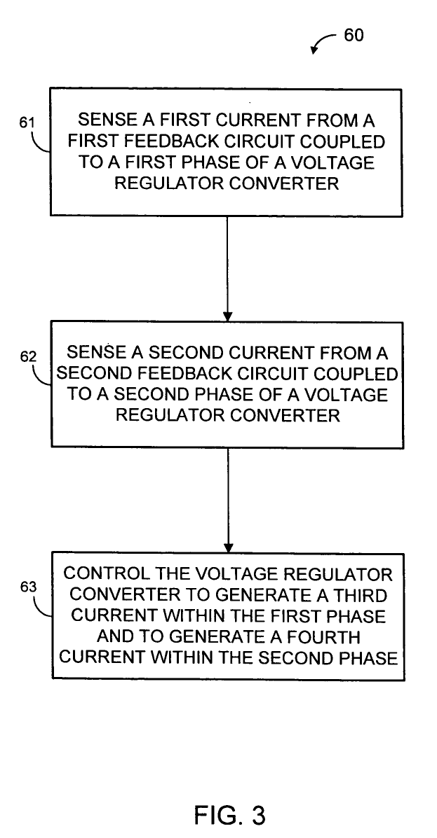

FIG. 3 is a flow diagram of process 60. Process 60 illustrates procedures executed by voltage regulator 10 according to some embodiments. The procedures may be executed by any combination of discrete components, integrated circuits, and/or software.

Initially, at 61, a first current is sensed from a first feedback circuit that is coupled to a first phase of a voltage regulator converter. According to some examples of 61, voltage regulator controller 12 senses a first current from feedback circuit 34, which is coupled to phase 30 voltage regulator converter 14. The sensed current may provide voltage regulator controller 12 with an indication of a supply current and/or supply voltage generated within phase 30 for delivery to IC 20.

Next, at 62, a second current is sensed from a second feedback circuit that is coupled to a second phase of the voltage regulator converter. Voltage regulator controller 12 senses the second current from feedback circuit 44 according to some embodiments. Again, the second sensed current may provide voltage regulator controller 12 with an indication of a supply current and/or supply voltage generated within phase 40 for delivery to IC 20.

According to some embodiments, the first sensed current and the second sensed current are substantially identical. Such a scenario may indicate to voltage regulator controller 12 that the supply current and the supply voltage generated by voltage regulator converter 14 are substantially identical and both fall within the design specifications of voltage regulator 10. If the first sensed current and the second sensed current are substantially identical, the current generated within phase 30 may be different from the current generated within phase 40, since feedback circuits 34 and 44 are not identical.

Therefore, voltage regulator converter 14 may be controlled at 63 to generate a third current within the first phase and to generate a fourth current that is different from the third current within the second phase. According to some embodiments, voltage regulator controller 12 controls voltage regulator converter 14 at 62 to ensure that the first sensed current and the second sensed current are substantially identical. As mentioned above, such a condition may require the third current to be different from the fourth current, since feedback circuits 34 and 44 are not identical.

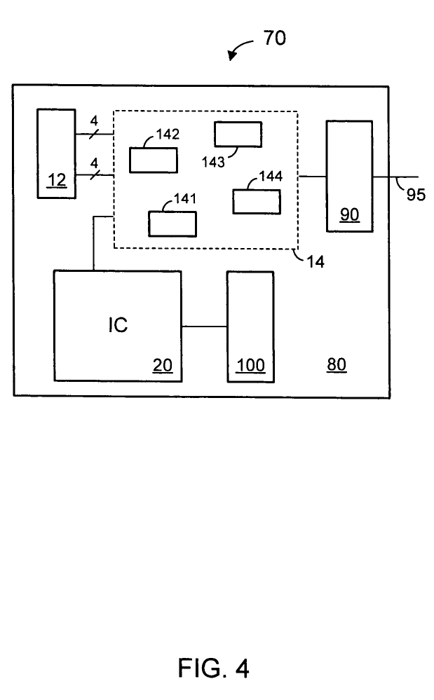

FIG. 4 illustrates a system to execute process 60 according to some embodiments. System 70 includes voltage regulator controller 12, voltage regulator converter 14, IC 20, motherboard 80, power supply 90, and memory 100. System 70 may comprise components of a desktop computing platform, and memory 100 may comprise any type of memory for storing data, such as a Single Data Rate Random Access Memory, a Double Data Rate Random Access Memory, or a Programmable Read Only Memory.

Voltage regulator converter 14 comprises a four phase converter including phases 141 through 144. Voltage regulator converter 14 receives DC power from power supply 90 (which in turn receives AC power from power cord 95) and regulates the DC power based on control signals received from voltage regulator controller 12. Motherboard 80 therefore includes four control signal lines coupled to controller 12 and converter 14, as well as four feedback circuit signal lines coupled to controller 12 and to feedback circuits associated with respective ones of phases 141 through 144. Each feedback circuit may be included within its respective phase, and at least one of the feedback circuits may include an electrical element having a value that is different from a corresponding electrical element of another of the feedback circuits. Motherboard 80 may also include signal lines of power bus 15. Similarly, motherboard 80 may route I/O signals between IC 20 and memory 100.

Phases 141 through 144 may be located on motherboard 80 based on the amounts of current respectively generated thereby. According to some embodiments, phase 143 may be located in a thermally-sensitive area of motherboard 80 and may be controlled to generate 6 A of current. Each of phases 141, 142, and 144 may be controlled to generate 8 A of current in order for regulator 14 to transmit a total of 30 A of supply current to IC 20. Moreover, feedback circuits coupled to each of phases 141 through 144 may be designed such that voltage regulator controller 12 senses a substantially identical current from each feedback circuit.

The several embodiments described herein are solely for the purpose of illustration. Some embodiments may include any currently or hereafter-known versions of the elements described herein. Therefore, persons skilled in the art will recognize from this description that other embodiments may be practiced with various modifications and alterations.

1. An apparatus comprising:
a voltage regulator converter, the voltage regulator converter comprising N (N>1) phases; and
a voltage regulator controller coupled to the voltage regulator converter and to control the voltage regulator converter to generate a first current within a first one of the N phases and to generate a second current within a second one of the N phases,
wherein the first current is different from the second current.

2. An apparatus according to claim 1, further comprising:
N feedback circuits, each of the N feedback circuits coupled to the voltage regulator controller and to one of the N phases, wherein one or more electrical elements of one of the N feedback circuits exhibits an electrical value that is different from an electrical value exhibited by a corresponding one or more electrical elements of another one of the N feedback circuits.

3. An apparatus according to claim 2, wherein the one or more electrical elements of the one of the N feedback circuits comprises a first resistor, wherein the one or more electrical elements of the another one of the N feedback circuits comprises a second resistor, and wherein a resistance value associated with the first resistor is different from a resistance value associated with the second resistor.

4. An apparatus according to claim 3, wherein the first resistor and the second resistor comprise current-sensing resistors.

5. An apparatus according to claim 1, further comprising:
N feedback circuits, each of the N feedback circuits coupled to the voltage regulator controller and to one of the N phases,
wherein the voltage regulator controller is to sense a first sensed current value from a first of the N feedback circuits coupled to the first one of the N phases in response to the first current,
wherein the voltage regulator controller is to sense a second sensed current value from a second of the N feedback circuits coupled to the second one of the N phases in response to the second current, and
wherein the first sensed current value and the second sensed current value are substantially identical.

6. An apparatus according to claim 5,
wherein the first of the N feedback circuits comprises a first current sensing resistor,
wherein the second of the N feedback circuits comprises a second current sensing resistor, and
wherein a resistance value associated with the first current sensing resistor is different from a resistance value associated with the second current sensing resistor.

7. An apparatus according to claim 5, wherein the first one of the N phases is located in a more thermally-sensitive area than the second one of the N phases, and wherein the first current is less than the second current.

8. An apparatus according to claim 1, wherein the first current is output by the first one of the N phases, and wherein the second current is output by the second one of the N phases.

9. An apparatus according to claim 1, wherein the first one of the N phases is located in a more thermally-sensitive area than the second one of the N phases, and wherein the first current is less than the second current.

10. A method comprising:
sensing a first current from a first feedback circuit coupled to a first phase of a voltage regulator converter;
sensing a second current from a second feedback circuit coupled to a second phase of the voltage regulator converter; and
controlling the voltage regulator converter to generate a third current within the first phase and to generate a fourth current within the second phase,
wherein the first current is substantially identical to the second current, and
wherein the third current is different from the fourth current.

11. A method according to claim 10, wherein sensing the first current comprises:
sensing the first current from a first current sensing resistor of the first feedback circuit, and
wherein sensing the second current comprises:
sensing the second current from a second current sensing resistor of the second feedback circuit.

12. A method according to claim 11,
wherein a resistance value associated with the first current sensing resistor is different from a resistance value associated with the second current sensing resistor.

13. A method according to claim 10, wherein the first phase is located in a more thermally-sensitive area than the second phase, and wherein the third current is less than the fourth current.

14. A method according to claim 10, wherein the first current is output by the first phase, and wherein the second current is output by the second phase.

15. A system comprising:
a microprocessor;
a double data rate memory coupled to the microprocessor; and
a voltage regulator to provide a voltage to the microprocessor, the voltage regulator comprising:
a voltage regulator converter, the voltage regulator converter comprising N (N>1) phases; and
a voltage regulator controller coupled to the voltage regulator converter and to control the voltage regulator converter to generate a first current within a first one of the N phases and to generate a second current within a second one of the N phases,
wherein the first current is different from the second current.

16. A system according to claim 15, further comprising:
N feedback circuits, each of the N feedback circuits coupled to the voltage regulator controller and to one of the N phases, wherein one or more electrical elements of one of the N feedback circuits exhibits an electrical value that is different from an electrical value exhibited by a corresponding one or more electrical elements of another one of the N feedback circuits.

17. A system according to claim 16, wherein the one or more electrical elements of the one of the N feedback circuits comprises a first resistor, wherein the one or more electrical elements of the another one of the N feedback circuits comprises a second resistor, and wherein a resistance value associated with the first resistor is different from a resistance value associated with the second resistor.

18. A system according to claim 15, further comprising:
N feedback circuits, each of the N feedback circuits coupled to the voltage regulator controller and to one of the N phases,
wherein the voltage regulator controller is to sense a first sensed current value from a first of the N feedback circuits coupled to the first one of the N phases in response to the first current,
wherein the voltage regulator controller is to sense a second sensed current value from a second of the N feedback circuits coupled to the second one of the N phases in response to the second current, and
wherein the first sensed current value and the second sensed current value are substantially identical.

19. A system according to claim 18,
wherein the first of the N feedback circuits comprises a first current sensing resistor,
wherein the second of the N feedback circuits comprises a second current sensing resistor, and
wherein a resistance value associated with the first current sensing resistor is different from a resistance value associated with the second current sensing resistor.

20. A system according to claim 15, wherein the first current is output by the first one of the N phases, and wherein the second current is output by the second one of the N phases.

21. A system according to claim 15, further comprising:
a motherboard coupled to the microprocessor and to the voltage regulator,
wherein the first one of the N phases is located in a more thermally-sensitive area of the motherboard than the second one of the N phases, and wherein the first current is less than the second current.
